(19) United States
(12) Patent Application Publication
(10) Pub. No.: US 2021/0131181 A1
(43) Pub. Date: May 6, 2021

(54) Secluded Step Stool

(71) Applicant: Lynn Hughes, Palm Beach Gardens, FL (US)

(72) Inventor: Lynn Hughes, Palm Beach Gardens, FL (US)

(21) Appl. No.: 16/930,288

(22) Filed: Jul. 15, 2020

Related U.S. Application Data
(60) Provisional application No. 62/874,395, filed on Jul. 15, 2019.

(51) Int. Cl. E06C 1/00

(52) U.S. Cl. CPC E06C 1/005

(57) ABSTRACT

A secluded step stool housed within the framework underneath the bottom of a base cabinet for use in reaching higher cabinets or shelving and for a child to reach a countertop. There are no limitations to the location of the base cabinet. The convenience and accessibility for this present invention, helps to provide assistance for many individuals and for many uses. With the push-open mechanism contained within this present invention providing a quick and easy access along with the 2 step horizontal surfaces, an individual with have a great reachability for those higher areas that cannot be achieved without the Secluded Step Stool.

### CROSS REFERENCE TO RELATED APPLICATIONS

This application claims the benefit of and is in continuation of Provisional Application No. 62/874,395 filed on Jul. 15, 2019.

### BACKGROUND OF THE INVENTION

### 1. Field of the Invention

This present invention relates to a secluded step system that is housed within the framework underneath the bottom of base cabinetry, for utilization when struggling to reach the higher cabinets and/or shelving or for a child to reach the countertop.

### 2. Description of Prior Art

In finding numerous styles of step stools provided in prior art for the purpose of obtaining a higher reach. Of these numerous styles it appears that the two options of the prior art either offering one step from within the same location as this present invention being submitted or the prior art offered one or two steps but the housing location was within the actual base cabinet.

With the prior art featuring only a single step, an individual may still find it difficult to reach the highest and furthest point within the upper cabinets and/or shelving or a child may have difficulty in reaching in a comfortable matter the top of the counter based upon the height of said individual. With the prior art that is housed within the actual base cabinet, utilizes too much of or all of the space required for storage within the base cabinet. Therefore, leaving the individual to locate another area for that storage. For these reasons, the Secluded Step Stool is needed. In providing a 2-step support system comprising of, an upper and lower horizontal surface step that is easily accessible from within the em sty space located behind the kick plate underneath the bottom of a base cabinet.

### STATEMENT REGARDING FEDERALLY SPONSORED RESEARCH OR DEVELOPMENT

N/A

REERENCE TO SEQUENCE LISTING, A TABLE OR A COMPUTER PROGRAM LISTING COMPACT DISK APPENDIX

N/A

### BRIEF SUMMARY OF THE INVENTION

The secluded step of this present invention offers a safe and convenient way that is easily accessible in gaining height when retrieving items from upper cabinets and/or shelves. It can also provide additional height to a child when reaching the top of a counter. Unlike the descriptions of prior art focusing in the area of the kitchen, this present invention can be installed in any base cabinet that requires the need to reach higher elevations whether the location of the cabinet is in the kitchen, bathroom, laundry room, closet, garage, office etc.

The secluded step comprises of a detached kickplate in the front framework underneath the base cabinet. In having the kickplate detachable, the individual will use a forward kicking motion to activate and engage the said push open mechanism of the heavy duty fully extendable slides in an outward forward motion. The said slides are mounted to the interior side walls within the framework underneath the bottom of the base cabinet and to the backside portion of the kickplate. Once the said slides are exposed, the individual by pulling the kickplate in a continued forward motion will complete the extension of the heavy-duty extendable slides.

Once in position, using the handle opening located on the upper horizontal surface step, the secluded step stool can be lifted and pulled back at a 90 degree angle allowing for the supportive rotational legs to completely pivot to a vertical position resting on the floor. Providing a convenient and safe way to reach the higher cabinet and/or shelves along with the capability of providing a child the height to reach the top of a counter without the need to transport a device from another location or taking the risk of climbing on the counters within the area.

To return the secluded step back into it's original housing within the framework, again using the handle opening located on the upper horizontal surface step, the secluded step linkage system allows for the steps to rotate and pivot back into its horizontal collapsed position behind the kickplate, where with the use of an individual's hand or foot can engage the soft close feature within the heavy duty extendable slides to retract the device back into place.

### BRIEF DESCRIPTION OF DRAWINGS

FIG. 1 is a side view of a standard kitchen. consisting of the upper cabinet, countertop and lower cabinet anchored to a wall and the floor. It is noticeable in this view, the struggle one has when reaching higher cabinet and/or shelving.

FIG. 2 is a top view of the secluded step in its collapsed and retracted configuration.

FIG. 3 is a side angled view of the secluded step in its collapsed and retracted configuration.

FIG. 4 is a side view of the standard kitchen cabinets as shown in FIG. 1 with a perspective view of the heavy duty fully extendable slide in its full extension from within the framework of the base cabinet along with the secluded step stool engaged in an upward rotational motion from its collapsed position.

FIG. 5 is a side view of the standard kitchen cabinets as shown in FIG. 1 with a perspective view of the heavy duty fully extendable slides in their full extension from within the framework of the base cabinet as well with the secluded step stool in its fully extended upright position providing the individual the capability of reaching higher elevations with ease.

### DETAILED DESCRIPTION OF THE INVENTION

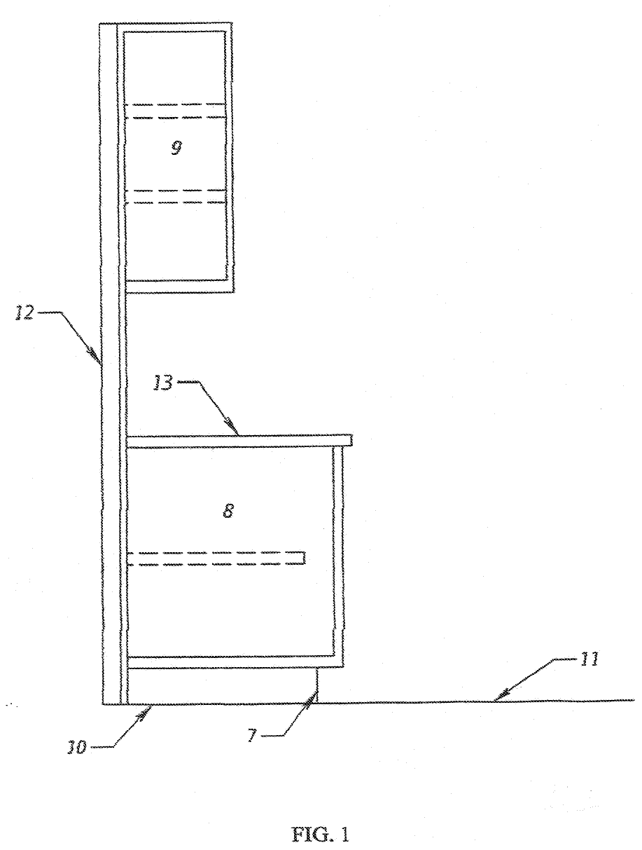

Referring to FIG. 1 is a side view of standard kitchen cabinets consisting of an upper cabinet 9 and a tower cabinet 8 both of which are mounted 6 on a wall 12 along with the lower cabinet supported by the floor 11. With this view, you will see the struggle that occurs when an individual of a shorter height attempts to reach the upper cabinets 9 and/or shelving without the use of the secluded step stool. In today's construction, upper kitchen cabinets are extending further up in height to the ceilings leaving no gap between the top of the upper cabinet and the ceiling. This providing additional storage for the homeowner. With the average ceiling height at 9ft.

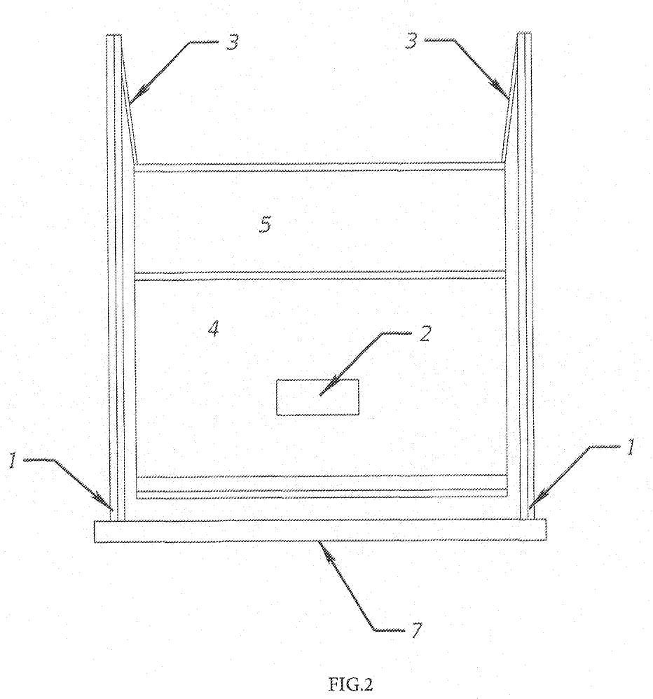

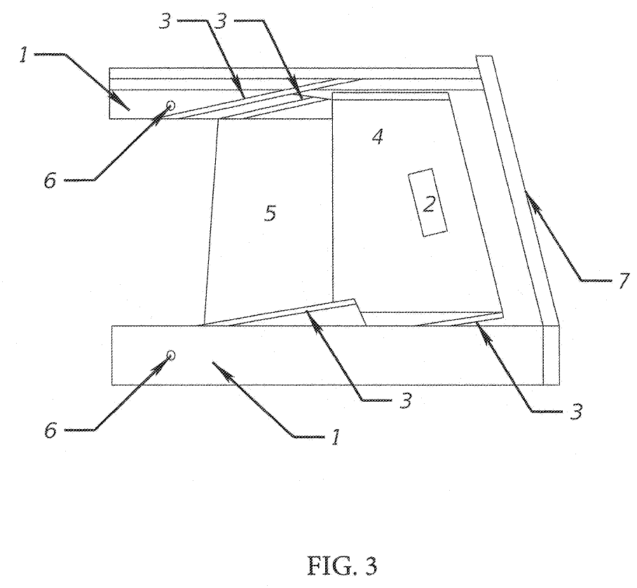

The secluded step stool, this present invention is a 2-step step stool that when collapsed within the framework 10 of the base cabinet 8, becomes secluded from sight. With a forward kicking motion to the detached kickplate 7, the push open mechanism that is contained within the heavy-duty extendable slides 1 becomes triggered to activate the secluded step in an outward forward motion exposing the secluded step stool as shown in FIGS. 2 and 3. These drawings provide a top and side view of the assembly. Notice the push open heavy-duty extendable slides 1 are connected 6 to the back side of the kickplate 7. One push-open heavy duty extendable slide is positioned on the left and one push-open heavy duty extendable slide 1 is positioned on the right of the kickplate.7 The positioning of each said slide 1 configured to the measurements of the interior framework 10 when connected to the kickplate 7 allowing for the retraction within the framework 10 of the base cabinet 8. From there, the 3 pairs of the supportive rotational legs 3 while configured and linked 6 in their rightful location (front, middle and back) to the interior sides of the push open heavy duty extendable slides 1, allowing for the bottom of each leg when fully rotated into the vertical position to rest of the floor 11 providing additional support. On the reverse side of said 2^{nd} and 3^{rd} pair of supportive rotational legs 3 the connection will occur with the interior top side of said s 3 to the outer back side edge of the upper horizontal surface step 5 for the 3^{rd} supportive rotational leg, 3. Whereas the connection 6 will occur with the interior top side of said legs 3 and the outer front side edge for the 2^{nd} pair of supportive rotational legs 3. Whereas the connection 6 will occur with the interior top side of said legs to the outer front side edge of the lower horizontal surface step 4 of for the 1^{st} pair of said supportive rotational legs 3.

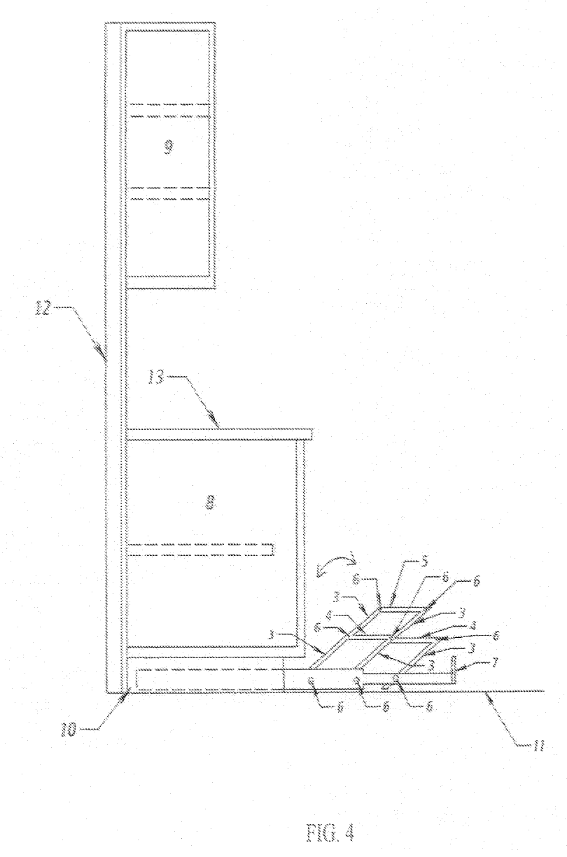

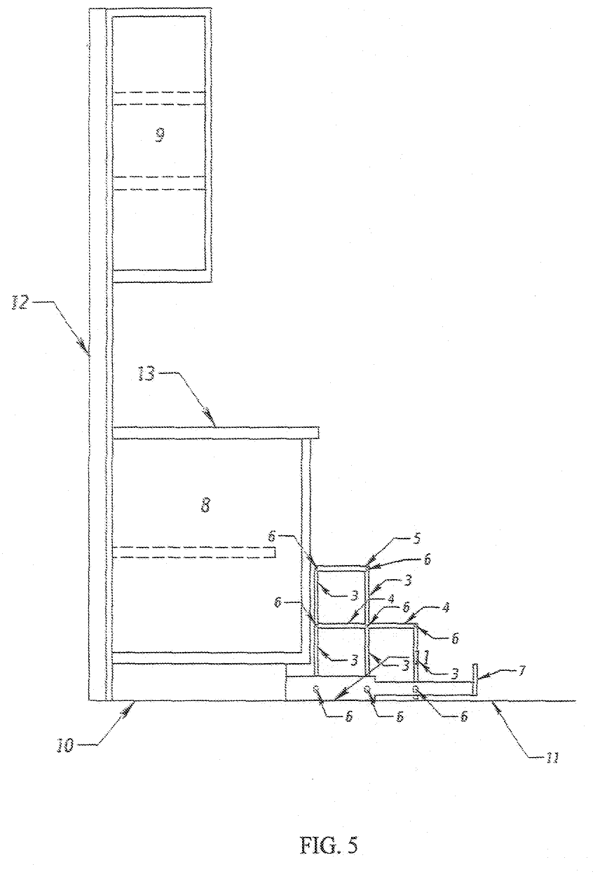

When initiating the use of the handle opening 2 located in the upper horizontal step surface 4 by lifting up and pulling back at a 90-degree angle, shown in FIG. 4, showing the pivotal movement from the collapsed positioning until the secluded step stool is completely engaged to it's full extension. FIG. 5. With this perspective view, the supportive rotational legs have not traveled from a collapsed stored horizontal position to a supportive vertical position on each side of the secluded step stool. With the said present invention in its full operable position, an individual who once struggled to reach higher cabinets and/or shelving will have the convenience and safety of using the Secluded Step Stool. As well as a child reaching the top of a counter.

What is claimed is:

1. A step support system housed in a horizontal position within the framework under underneath the bottom of a base cabinet comprising of:
A detached kickplate of said framework
A 1^{st} and 2^{nd} heavy duty extendable sliding apparatus
A 1^{st} and 2^{nd} push open mechanism contained within the heavy-duty extendable sliding apparatus.
A 1^{st} horizontal step surface
A 2^{nd} horizontal step surface with a handle opening
A pair of 1^{st} supportive rotational legs at a reduced height
A pair of 2^{nd} supportive rotational legs at a higher height
A pair of 3^{rd} supportive rotational legs at a higher height equivalent to the 2^{nd} pair of supportive rotational legs

2. A step support system as stated in claim 1 wherein the, 1^{st} and 2^{nd} heavy duty extendable sliding apparatus mounted to the inside framework walls underneath the bottom of the base cabinet.

3. A step support system as stated in claim 1 wherein the backside of the kickplate mounted to to the end, cap of said 1^{st} and 2^{nd} heavy duty extendable sliding apparatus.

4. A step support system as stated in claim 1 where in the 1^{st} pair of supportive rotational legs are vertically connected through a linked device at the front section of said 1^{st} and 2^{nd} heavy duty sliding apparatus.

5. A step support system as stated in claim 1 wherein the 2^{nd} pair of supportive rotational legs are vertically connected through a linked device at the middle section of said 1^{st} and 2^{nd} heavy duty extendable sliding apparatus.

6. A step support system as stated in claim 1 wherein the 3^{rd} pair of supportive rotational legs are vertically connected with a linked device at the back section of said 1^{st} and 2^{nd} heavy duty extendable sliding apparatus.

7. A step support system as stated in claim 1 wherein the 2^{nd} horizontal step surface is pivotally connected to the inner top portion of said 2^{nd} and 3^{rd} supportive rotational legs.

8. A step support system as stated in claim 1 wherein the 1^{nd} horizontal step surface is pivotally connected to the inner top portion of said 1^{st} supportive rotational leg.
